(19) United States
(12) Patent Application Publication
(10) Pub. No.: US 2019/0079459 A1
(43) Pub. Date: Mar. 14, 2019

(54) SMARTWATCH WITH PRESSURE SENSING FUNCTION

(71) Applicant: HUAWEI TECHNOLOGIES CO., LTD., Shenzhen, Guangdong (CN)

(72) Inventors: Duo SUN, Shenzhen (CN); Zhihong TANG, Shenzhen (CN); Zhiyong WANG, Shenzhen (CN)

(21) Appl. No.: 15/767,257

(22) PCT Filed: Apr. 14, 2016
(86) PCT No.: PCT/CN2016/079288

§ 371 Date: Apr. 10, 2018

(51) Int. Cl. G04B 47/06; G06F 3/041; G06F 3/044; G04G 21/08; G06F 1/16

(52) U.S. Cl. CPC G04B 47/06; G06F 3/0416; G04G 21/02; G04G 21/08; G06F 1/163; G06F 3/044

(57) ABSTRACT

A smartwatch with a pressure sensing function is disclosed. The smartwatch includes a watch body and a wristband. The watch body includes a front case, a touchscreen, a bottom case, at least one processor, and a pressure sensor that is disposed on the bottom case. In some instances, when pressure is applied to a touchscreen, the watch body transfers the pressure to a contact surface, and the contact surface exerts a reacting force to the pressure sensor on the bottom case. In some instances, the at least one processor obtains position coordinates from the touchscreen and obtains a pressure value from the pressure sensor.

### TECHNICAL FIELD

The present invention relates to the field of mechanical structures, and specifically, to a smartwatch with a pressure sensing function.

### BACKGROUND

Pressure sensing can not only determine user action information more accurately, but also provide more possibilities for UI (User interface) design. Especially for a 1.2- to 1.4-inch screen commonly used by a smartwatch, more functions can be developed in limited watch face space based on pressure sensing to enhance user experience.

In the prior art, a capacitive pressure sensor is added under a screen. The pressure sensor is in a chip or annular form, and is attached to a bottom of a display module or a metal middle frame carrying the display module. There is a slight gap between the display module and the metal middle frame. Pressure from the screen causes minor deformation of the sensor, and further results in a capacitance change. A signal processing circuit detects a capacitance change value, so as to sense pressure of different levels. This solution has a relatively high requirement on structural fit design, and especially, imposes a rather high requirement on a device assembly technology.

In another prior art, a pressure sensor is directly embedded in a display module. For example, a layer of transparent pressure sensor is added under a glass cover (cover lens), and the pressure sensor may be resistive or capacitive. The sensor can directly sense pressure from a screen, and a resistance or capacitance change is generated. A signal processing circuit identifies a resistance or capacitance change value, so as to sense pressure of different levels. In this solution, an existing display module fabrication process needs to be changed, and a yield rate of the display module is reduced.

### SUMMARY

In view of this, embodiments of the present invention provide a smartwatch with a pressure sensing function, so as to overcome such prior-art disadvantages as high fabrication difficulty and complex processes in smartwatch pressure sensing, and implement a simple and practical pressure sensing function.

According to a first aspect, an embodiment of the present invention provides a smartwatch, including a watch body and a wristband, where the watch body includes a front case, a touchscreen, and a bottom case, a circuit board is included inside the watch body, there are components such as a processor on the circuit board, and a pressure sensor is disposed on the bottom case. Optionally, the pressure sensor may be a pressure-sensitive film and is attached to the bottom case, so as to reduce an overall thickness of the watch body. The attachment may be implemented by using viscose glue, a buckle, a screw, or the like.

With reference to the first aspect, in a first implementation of the first aspect, there is a through-hole in the bottom case, and a signal connection line of the pressure sensor may pass through the through-hole and be electrically connected to a connection point of the circuit board, so as to implement communication between the pressure sensor and the processor.

With reference to the first aspect, in a second implementation of the first aspect, there is a groove in a lower surface of the bottom case, and a shape of the groove may be the same as a shape of the pressure sensor, that is, the pressure sensor may be placed in the groove. A bottom case thickness at a groove position is less than a bottom case thickness at a non-groove position. Optionally, there may be a through-hole in the groove, and a signal connection line of the pressure sensor passes through the through-hole and is electrically connected to a connection point of the circuit board, so as to implement communication between the pressure sensor and the processor. Optionally, when the pressure sensor is placed in the groove, a plane on which the pressure sensor is located may be slightly higher than the lower surface of the bottom case, that is, a part of the pressure sensor may protrude from the groove. This reduces an overall thickness of the smartwatch and also ensures detection sensitivity.

With reference to the first aspect, in a third implementation of the first aspect, there is a hole in the bottom case, and a shape of the hole may be the same as a shape of the pressure sensor, that is, the pressure sensor may be placed in the hole. Optionally, a signal connection line of the pressure sensor may directly pass through the hole and be electrically connected to a connection point of the circuit board, so as to implement communication between the pressure sensor and the processor. Optionally, diameters of the hole on both surfaces of the bottom case may be different. A diameter on an upper surface may be slightly smaller than a diameter on a lower surface, so that the pressure sensor is better secured. Optionally, when the pressure sensor is placed in the hole, a plane on which the pressure sensor is located may be slightly higher than the lower surface of the bottom case, that is, a part of the pressure sensor may protrude from a groove. This reduces an overall thickness of the smartwatch and also ensures detection sensitivity.

In all of the foregoing implementations, the pressure sensor may be covered with a protective cover for protection and decoration. The protective cover may be insulative.

According to the foregoing solutions, difficulty in implementing pressure sensing is reduced, and practical and diverse pressure sensing functions and man-machine interaction modes are provided for a user.

### BRIEF DESCRIPTION OF DRAWINGS

FIG. 1 is a schematic diagram of a smartwatch according to an embodiment of the present invention;

FIG. 2 is a schematic exploded view of a smartwatch according to an embodiment of the present invention;

FIG. 3 is a schematic exploded view of a smartwatch having a through-hole in a bottom case according to an embodiment of the present invention;

FIG. 4 is a schematic exploded view of a smartwatch having a groove in a lower surface of a bottom case according to an embodiment of the present invention;

FIG. 5 is a schematic exploded view of a smartwatch having a hole in a bottom case according to an embodiment of the present invention;

FIG. 6 is a schematic exploded view of a smartwatch having a protective cover according to an embodiment of the present invention; and

FIG. 7 is a schematic diagram of detecting a touch pressure value by using a pressure sensor according to an embodiment of the present invention.

### DESCRIPTION OF EMBODIMENTS

The technical solutions according to the embodiments of the present invention are clearly and completely described in the following with reference to the accompanying drawings.

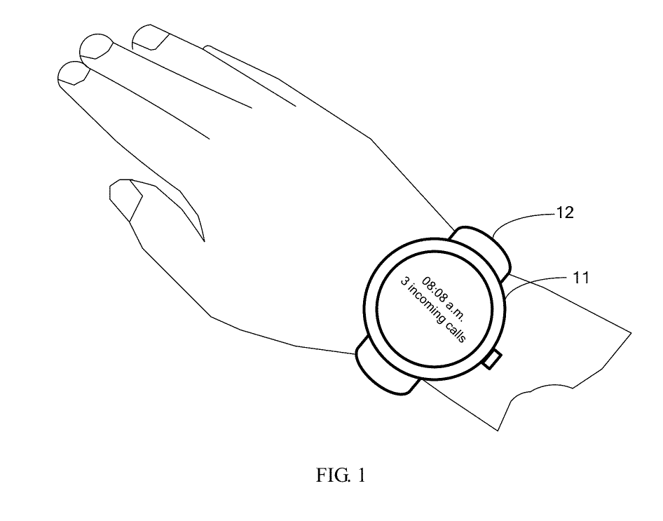

Referring to FIG. 1, an embodiment of the present invention relates to a smartwatch. The smartwatch may communicate with a base station on a network side or another mobile phone in a wireless manner. For example, the smartwatch may send, by using a radio frequency circuit and an antenna of the smartwatch, a radio signal to the base station, to request the base station to process a wireless network service. For another example, the smartwatch may perform pairing with a mobile phone by using a Bluetooth module of the smartwatch, and after the pairing succeeds, perform data communication with the mobile phone by using Bluetooth. Certainly, the smartwatch may alternatively perform data communication with the mobile phone in another wireless communication manner, such as a radio frequency identification technology or a near field communication technology. In addition, the smartwatch may also detect an ambient change by using various sensors of the smartwatch. The smartwatch may include a watch body 11 and a wristband 12. The watch body 11 includes a front case, a touch panel (also referred to as a touchscreen), and a bottom case. A circuit board is included inside the watch body 11. On the circuit board, there are electronic components, such as a processor, an antenna, a WiFi module, a Bluetooth module, a speaker, a microphone, a vibration motor, an accelerometer, and a gyroscope.

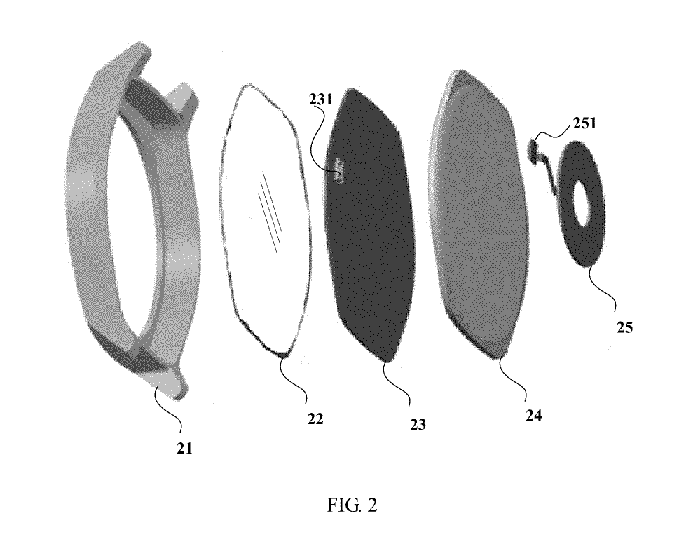

Referring to FIG. 2, an embodiment of the present invention provides a smartwatch with a pressure sensing function. The smartwatch includes a front case 21, a touchscreen 22, a circuit board 23, and a bottom case 24 from left to right in FIG. 2, and a pressure sensor 25 is disposed on the bottom case 24. The foregoing components are stacked successively as shown in FIG. 2. The bottom case 24 has two surfaces. The one closer to the circuit board 23 is an upper surface, and the one further away from the circuit board 23 is a lower surface. The circuit board 23 has lines of printed circuits formed by using various processes, and various electronic components. The circuit board 23 is a circuit that implements core functions of the smartwatch, including wireless communication, information storage, and man-machine interaction. There is a connection point 231 on the circuit board 23. The connection point 231 may be a solder joint, and may fasten a connection line of an electronic component onto the circuit board 23, to implement an electrical connection between the electronic component and the circuit board 23.

A signal connection line 251 of the pressure sensor 25 may be an FPC board (Flexible Printed Circuit board). Specifically, a BTB (Board to Board) connector or a spring clip may be connected to the connection point 231 of the circuit board 23, so as to implement communication between the pressure sensor 25 and a processor. Optionally, the pressure sensor 25 may be a pressure-sensitive film, and is attached to the bottom case 24, so as to further reduce an overall thickness of a watch body. Specifically, the attachment may be implemented by using viscose glue, a buckle, a screw, or the like.

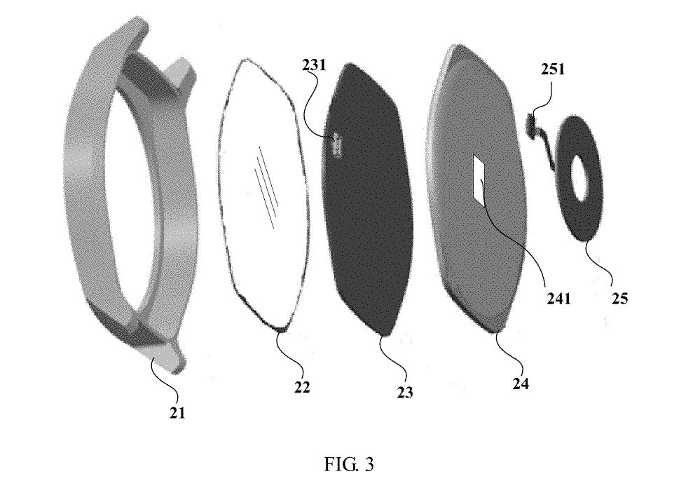

Referring to FIG. 3, in an embodiment of the present invention, there is a through-hole 241 in a bottom case 24, and a signal connection line 251 of a pressure sensor 25 may pass through the through-hole 241 and be electrically connected to a connection point 231 of a circuit board 23, so as to implement communication between the pressure sensor 25 and a processor.

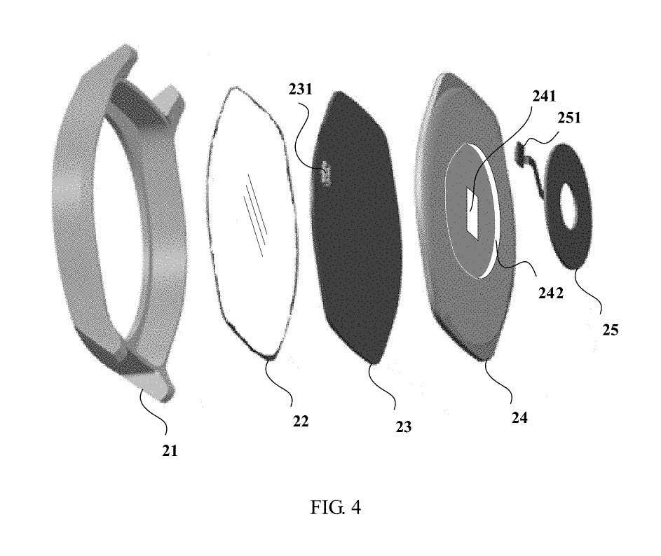

Referring to FIG. 4, in another embodiment of the present invention, there is a groove 242 in a lower surface of a bottom case 24. A shape of the groove 242 is the same as a shape of a pressure sensor 25, that is, the pressure sensor 25 may be placed in the groove. A bottom case thickness at a groove position is less than a bottom case thickness at a non-groove position. Optionally, there may be a through-hole 241 in the groove 242. A signal connection line 251 of the pressure sensor 25 may pass through the through-hole 241 and be electrically connected to a connection point 231 of a circuit board 23, so as to implement communication between the pressure sensor 25 and a processor. Optionally, when the pressure sensor 25 is placed in the groove, a plane on which the pressure sensor 25 is located may be slightly higher than the lower surface of the bottom case 24, that is, a part of the pressure sensor may protrude from the groove. Specifically, the part of the pressure sensor that protrudes from the groove may range from 0.01 millimeter to 2.0 millimeters, for example, 0.1 millimeter, 0.5 millimeter, 1.0 millimeter, 1.5 millimeters, or 2.0 millimeters. This reduces an overall thickness of a smartwatch and also ensures detection sensitivity.

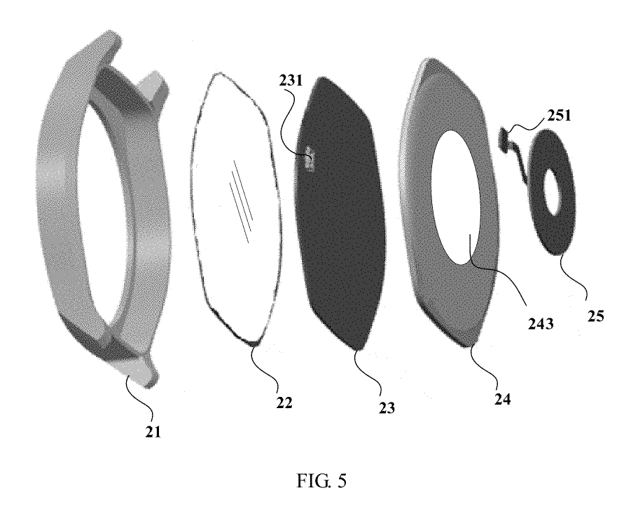

Referring to FIG. 5, in another embodiment of the present invention, there is a hole 243 in a bottom case 24. A shape of the hole 243 is the same as a shape of a pressure sensor 25, that is, the pressure sensor 25 may be placed in the hole 243. Optionally, a signal connection line 251 of the pressure sensor 25 directly passes through the hole 243 and is electrically connected to a connection point 231 of a circuit board 23, so as to implement communication between the pressure sensor 25 and a processor. Optionally, an edge of the pressure sensor 25 may be fastened to the hole 243 by using viscose glue, a buckle, a screw, or the like. Diameters of the hole 243 on both surfaces of a bottom case 24 may be different. A diameter on an upper surface may be slightly smaller than a diameter on a lower surface, so that the pressure sensor 25 is better secured to the hole 243. Optionally, when the pressure sensor 25 is placed in the hole 243, a plane on which the pressure sensor 25 is located may be slightly higher than the lower surface of the bottom case 24, that is, a part of the pressure sensor may protrude from a groove. Specifically, the protruding part may range from 0.01 millimeter to 2.0 millimeters, for example, 0.1 millimeter, 0.5 millimeter, 1.0 millimeter, 1.5 millimeters, or 2.0 millimeters. This reduces an overall thickness of a smartwatch and also ensures detection sensitivity.

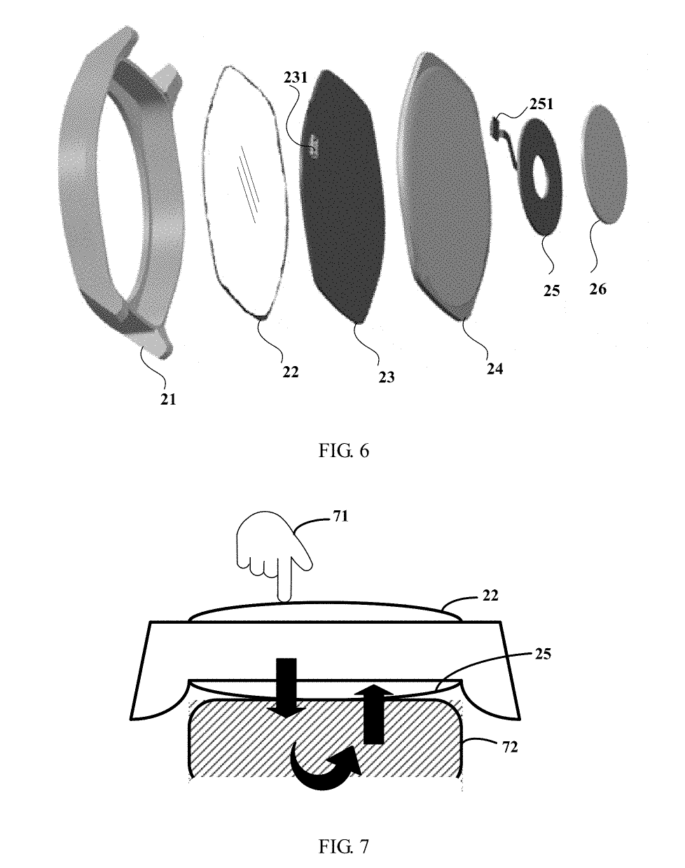

Referring to FIG. 6, in all the foregoing embodiments, optionally, the pressure sensor 25 may be covered with a protective cover 26 for protection and decoration. Further, the protective cover 26 may be insulative.

The smartwatch in the embodiments of the present invention may detect position coordinates and a pressure value of a touch operation of a user. The touch operation may be performed by touching a touchscreen by using an appropriate part or object such as a finger or a stylus. The touchscreen includes a touch-sensitive surface (touch-sensitive surface) and a display (display). The touch-sensitive surface is used to perform various operations related to detection of contact, such as determining whether contact has occurred (for example, detecting a finger press event), determining whether there is a contact movement and tracking the movement on the entire touch-sensitive surface (for example, detecting a drag event by one or more fingers), and determining whether the contact has been terminated (for example, detecting a finger lift event or a contact interruption). Determining a movement of a contact point may include determining a speed (a value), a velocity (a value and a direction), and/or an acceleration (a change of a value and/or a direction) of the contact point. The movement of the contact point is indicated by a series of contact data. These operations can be applied to a single-point touch (such as touch by one finger) and a simultaneous multi-point touch (such as a multi-point touch/touch by multiple fingers). The display displays a visual output to a user. The visual output includes a text, a graphic, an icon, a video, and any combination thereof.

Referring to FIG. 7, a principle that a smartwatch detects a pressure value of a touch operation by using a pressure sensor 25 is as follows: When pressure of a touch operation is applied to a touchscreen 22, for example, when the touchscreen 22 is pressed by a finger 71, a watch body transfers the pressure to a contact surface 72, the contact surface 72 exerts a reacting force to the pressure sensor 25, and the pressure sensor 25 may detect the pressure and obtain a pressure value. The contact surface 72 is any surface that is in contact with a lower surface of the watch body. For example, when the watch is worn, a wrist that is in contact with a bottom case of the watch is the contact surface; when the watch is placed on a table, the table surface is the contact surface.

When a user performs a touch operation on the touchscreen, the touchscreen can detect position coordinate information (x,y) of the touch operation, and the pressure sensor can detect a pressure value z of the touch operation. The position coordinate information and the pressure value may be sent to a processor. The processor processes the received position coordinate information and pressure value to obtain a position and a pressure of the touch operation. With reference to parameters such as a touch time, a moving speed of touch, and a moving acceleration of touch as well as UI design and an upper-layer application, practical and diverse pressure sensing functions and man-machine interaction modes are provided for users, and more functions are developed in limited watch face space to enhance user experience.

The foregoing descriptions are merely some specific implementations of the present invention, but are not intended to limit the protection scope of the present invention. Any equivalent change or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A smartwatch, comprising a watch body and a wristband, wherein the watch body comprises a front case, a touchscreen, a bottom case, at least one processor, and a pressure sensor that is disposed on the bottom case.

2. The smartwatch according to claim 1, wherein the pressure sensor is a pressure-sensitive film.

3. The smartwatch according to claim 1, wherein the bottom case comprises a through-hole.

4. The smartwatch according to claim 3, wherein a signal connection line of the pressure sensor passes through the through-hole to communicate with the at least one processor.

5. The smartwatch according to claim 1, wherein a lower surface of the bottom case comprises a groove, and a shape of the groove is the same as a shape of the pressure sensor.

6. The smartwatch according to claim 1, wherein the bottom case comprises a hole, and a shape of the hole is the same as a shape of the pressure sensor.

7. The smartwatch according to claim 1, wherein the pressure sensor is covered with a protective cover.

8. The smartwatch according to claim 7, wherein the protective cover is insulative.

9. A method, comprising:
receiving, at a touchscreen of a smartwatch, a touch, wherein the smartwatch comprises a watch body and a wristband, and the watch body comprises a front case, a touchscreen, a bottom case, at least one processor, and a pressure sensor that is disposed on the bottom case;
detecting, by the pressure sensor, a pressure value of the touch; and
sending the pressure value from the pressure sensor to the at least one processor.

10. The method according to claim 9, further comprising:
detecting, by the touchscreen, a position coordinate of the touch; and
sending the position coordinate from the touchscreen to the at least one processor.

11. The method according to claim 9, wherein the pressure sensor is a pressure-sensitive film.

12. The method according to claim 9, wherein the bottom case comprises a through-hole.

13. The method according to claim 12, wherein a signal connection line of the pressure sensor passes through the through-hole to communicate with the at least one processor.

14. The method according to claim 9, wherein a lower surface of the bottom case comprises a groove, and a shape of the groove is the same as a shape of the pressure sensor.

15. The method according to claim 9, wherein the bottom case comprises a hole, and a shape of the hole is the same as a shape of the pressure sensor.

16. The method according to claim 9, wherein the pressure sensor is covered with a protective cover.

17. The method according to claim 16, wherein the protective cover is insulative.
